(19) United States
(12) Patent Application Publication
(10) Pub. No.: US 2026/0290835 A1
(43) Pub. Date: Sep. 24, 2026

(54) Novel polynaphthalimide, electrode comprising the same and lithium-ion battery comprising the same

(71) Applicant: Academia Sinica, Taipei City (TW)

(72) Inventors: Hung-Ju YEN, Taipei City (TW); Febri BASKORO, Taipei City (TW); Andre Lammiduk LUBIS, New Taipei City (TW)

(21) Appl. No.: 19/473,594

(22) PCT Filed: Apr. 10, 2024
(86) PCT No.: PCT/US2024/023779

§ 371 Date: Oct. 8, 2025

Related U.S. Application Data
(60) Provisional application No. 63/458,242, filed on Apr. 10, 2023.

(51) Int. Cl. H01M 4/62; C08G 73/06; H01M 4/13; H01M 10/0525

(52) U.S. Cl. CPC H01M 4/628; C08G 73/0688; H01M 4/13; H01M 4/625; H01M 10/0525

(57) ABSTRACT

Disclosed is a novel polynaphthalimide which comprises a repeat unit represented by the following formula (I) wherein naphthalimide is bonded to substructure A, wherein A is a cyano-substituted arylamine moiety. The polynaphthalimide polymer provides an electrode material disposed on an electrode collector, wherein the electrode may be a cathode or an anode, said electrode comprising the disposed polynaphthalimide is utilized in a lithium-ion battery, providing an efficient storage capability of the newly designed triphenylamine-based polynaphthalimides (TPA-PNIs) and exhibiting outstanding electrochemical performance and operation durability.

### CROSS-REFERENCE TO RELATED APPLICATIONS

This application claims the benefit of filing date of U.S. Provisional Application Ser. No. 63/458,242, filed Apr. 10, 2023 under 35 USC § 119 (e) (1).

### BACKGROUND OF THE INVENTION

### Field

The present invention relates to a novel polynaphthalimide, an electrode comprising the same and a lithium-ion battery comprising the same.

### Description of Related Art

Owning series of advantages such as light weight, high energy density, fast charging ability, and low self-discharge rate, lithium-ion batteries (LiBs) has been played crucial role in portable energy storage devices and replaced many other energy storage systems. Besides their technological advancement, the use of inorganic electrode materials in LiBs are hindered by limited source of non-earth abundant elements, cost intensive, and environmental issue. Furthermore, these materials usually suffer from severe structural degradation and oxygen loss (especially for metal-rich layered cathodes) during long-term cycling process. Therefore, the utilization of sustainable and environmental friendly materials are highly encourage.

Organic materials have drawn attention as an alternative electrode for the next-generation LiBs because of high abundance, low-cost, structural diversity, tunable electronic property, and environmental inertness. Despite of these advantages, organic electrode materials generally suffer from low structure reversibility and stability to ensure long cycle life due to their high solubility in electrolytes, especially for small organic molecules, and therefore reduces overall performance. Polymerizing small organic compounds is an effective solution to deter the so-called electrode dissolution in non-aqueous electrolyte, and hence enhances the structural integrity of these organic materials.

Polyimides have been known as high-performance polymeric materials due to their thermal stability, solvent resistance, good electrical and mechanical properties, as well as great chemical resistance. The redox-active carbonyl group in polyimides is responsible for the Li-ion storage capability via formation of two-electron enolization reaction process as cathode materials. Comparing with small molecular imide analogs, polyimide cathode materials performed an improved cycling stability. However, the low working potential of polyimide-based cathode based on enolization process (2.0-2.5 V) severely hindered its practical application.

Therefore, it is desirable to provide a novel polyimide analog which can be applied to the lithium-ion batteries.

### SUMMARY OF THE INVENTION

The present invention provides a novel polynaphthalimide, which comprises a repeat unit represented by the following formula (I):

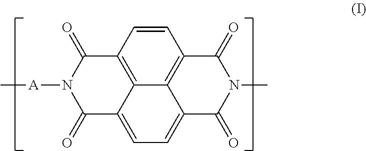

wherein A is a cyano-substituted arylamine moiety.

The present invention also provides an electrode, which comprises: a collector; and an electrode material disposed on the collector and comprising the aforesaid polynaphthalimide.

The present invention further provides a lithium-ion battery, which comprises: the aforesaid electrode; a counter electrode disposed opposite to the electrode; and an electrolyte disposed between the electrode and the counter electrode.

Other novel features of the disclosure will become more apparent from the following detailed description when taken in conjunction with the accompanying drawings.

### BRIEF DESCRIPTION OF DRAWINGS

FIG. 1A to FIG. 1C show the cyclic voltammetry of TPA-PNI electrodes as cathode at scan rate of 0.1 mV s⁻¹.

FIG. 1D to FIG. 1F show the cyclic voltammetry of TPA-PNI electrodes as anode at scan rate of 0.1 mV s⁻¹.

FIG. 2A shows the capacity profile of TPA-PNI cathodes at current density of 50 mA g⁻¹.

FIG. 2B shows the rate performance of TPA-PNI cathodes.

FIG. 2C shows the long cycling performance of TPA-PNI cathodes at 2000 mA g⁻¹.

FIG. 3A show the capacity profile of TPA-PNI anodes at 100 mA g⁻¹ current density.

FIG. 3B show the rate performance of TPA-PNI anodes.

FIG. 3C show the long cycling performance of TPA-PNI anodes at 5000 mA g⁻¹.

FIG. 4A to FIG. 4C show the typical CV curves of PNI-1, PNI-2, and PNI-3 cathodes at various scan rates, respectively.

FIG. 4D to FIG. 4F show the charge storage contribution at different voltage ranges of PNI-1, PNI-2, and PNI-3 cathodes, respectively.

FIG. 5A to FIG. 5C show the Nyquist plot of PNI-1, PNI-2, and PNI-3 at various temperatures, respectively.

FIG. 5D shows the Log i₀ vs 1000/T plot of PNI-1, PNI-2, and PNI-3.

FIG. 6A and FIG. 6B show the CV curves of binder-free PNI-1 and binder-free PNI-2 cathodes, respectively.

FIG. 6C shows the capacity profile of binder-free PNI-1 and binder-free PNI-2 cathodes at 50 mA g⁻¹.

FIG. 6D shows the rate performance of binder-free PNI-1 and binder-free PNI-2 cathodes.

FIG. 6E shows the long cycling performance of binder-free PNI-1 and binder-free PNI-2 cathodes at 2000 mA g⁻¹.

### DETAILED DESCRIPTION OF THE INVENTION

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

The present invention provides a novel polynaphthalimide, which comprises a repeat unit represented by the following formula (I):

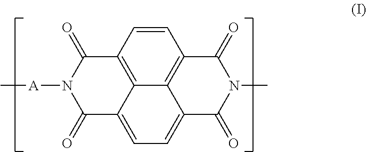

wherein A is a cyano-substituted arylamine moiety.

In one embodiment, the polynaphthalimide may be represented by the following formula (I′):

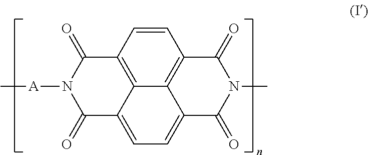

wherein A is a cyano-substituted arylamine moiety, and n is an integer ranging from 5 to 10000.

In one embodiment, A may be a cyano-substituted phenylamine moiety or a cyano-substituted phenylenediamine moiety.

In one embodiment, A may be represented by the following formula (II):

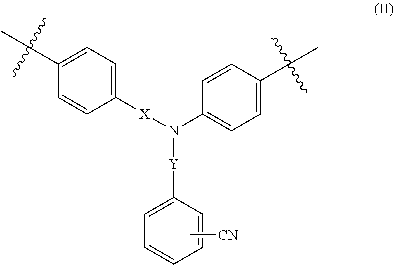

wherein X is a bond or

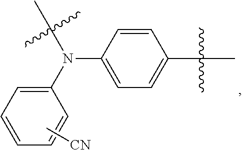

and Y is a bond or

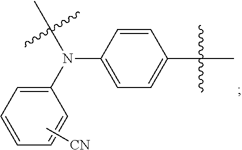

and
with the proviso that N of X or Y is not bond to N in the formula (II).

In one embodiment, A may be represented by the following formula (II-1):

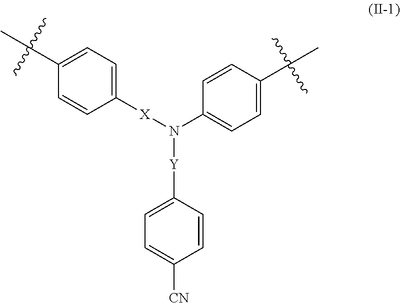

wherein X is a bond or

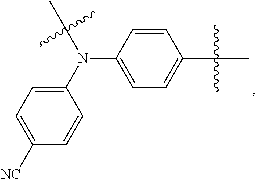 [SMILES: *c1ccc(N(*)c2ccc(C#N)cc2)cc1]

and Y is a bond or

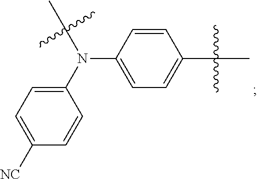 [SMILES: *c1ccc(N(*)c2ccc(C#N)cc2)cc1]

and
with the proviso that N of X or Y is not bond to N in the formula (II-1).

In one embodiment, the repeat unit of the polynaphthalimide may be any one represented by the following formulas (I-1), (I-2) and (I-3):

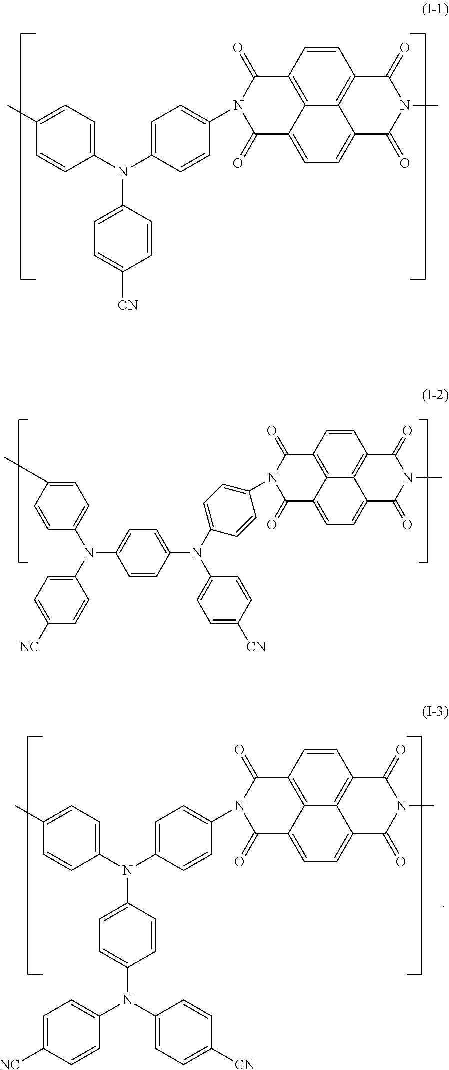

In one embodiment of the present invention, the above polynaphthalimide having the repeat unit represented by the formulas (I-1), (I-2) or (I-3) may be respectively prepared by reacting naphthalenetetracarboxylic dianhydride (NTDA) with a diamine monomer represented by the following (III-1), (III-2) or (III-3):

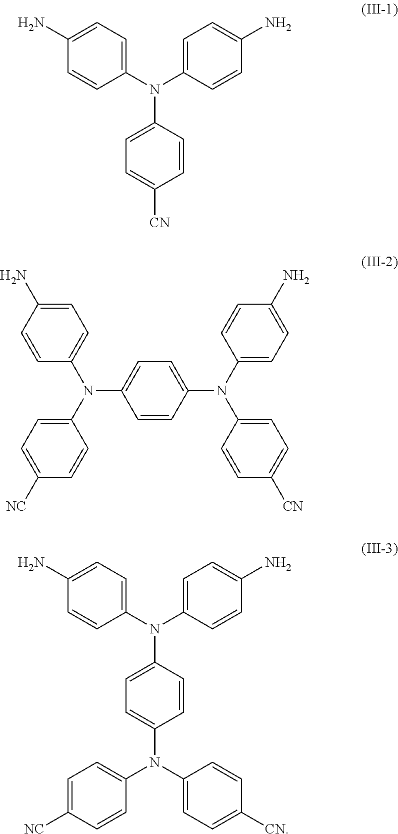

The present invention also provides an electrode, which comprises: a collector; and an electrode material disposed on the collector and comprising any of the aforesaid polynaphthalimide.

In one embodiment, the electrode may be a cathode.

In one embodiment, the electrode may be an anode.

In one embodiment, the electrode material may further comprise: an active material; a conductive carbon; and a binder, wherein an average mass loading of the polynaphthalimide ranges from 0.2 mg/cm² to 1.0 mg/cm². In one embodiment, a content of the active material may be 20 wt % to 60 wt %, a content of the conductive carbon may be 30 wt % to 70 wt %, and a content of the binder may be 2 wt % to 15 wt % based on a total weight of the electrode material.

In one embodiment, the electrode material may further comprise: an active material; and a conductive carbon, wherein an average mass loading of the polynaphthalimide ranges from 0.2 mg/cm² to 1.0 mg/cm², and no other binders are present in the electrode material. In this embodiment, the polynaphthalimide may be used as a binder. In one embodiment, a content of the active material may be 20 wt % to 70 wt % and a content of the conductive carbon may be 30 wt % to 80 wt % based on a total weight of the electrode material.

In one embodiment, in the case that the electrode is a cathode, the active material may be lithium cobalt oxide (LiCoO₂), lithium manganese oxide (LiMn₂O₄), lithium iron phosphate (LiFePO₄), lithium nickel manganese cobalt oxide (LiNiMnCoO₂) or a combination thereof. However, the present invention is not limited thereto, and any known active material used in the cathode of the lithium-ion battery may be used in the anode material of the present invention.

In one embodiment, in the case that the electrode is an anode, the active material may be graphite, carbon fibers, carbon nanotubes or a combination thereof. However, the present invention is not limited thereto, and any known active material used in the anode of the lithium-ion battery may be used in the cathode material of the present invention.

In one embodiment, the binder may be polyvinylidene difluoride (PVDF), styrene butadiene rubber (SBR), carboxymethyl cellulose (CMC) or a combination thereof. However, the present invention is not limited thereto, and any known binder used in the lithium-ion battery may be used in the electrode of the present invention.

In one embodiment, in the case that polynaphthalimide is used as a binder, no other binders are present in the electrode except for the polynaphthalimide of the present invention.

The present invention further provides a lithium-ion battery, which comprises: any of the aforesaid electrode; a counter electrode disposed opposite to the electrode; and an electrolyte disposed between the electrode and the counter electrode.

In one embodiment, the electrolyte may comprise a lithium salt. Examples of the lithium salt may comprise, but are not limited to, LiBF₄, LiPF₆, LiAsF₆, LiClO₄ or a combination thereof. Other known lithium salt for the lithium-ion battery may also be used in the present invention.

In one embodiment, the electrolyte may also comprise a solvent. Examples of the solvent may comprise, but are not limited to ethylene carbonate (EC), propylene carbonate (PC), dimethyl carbonate (DMC), diethyl carbonate (DEC), ethyl methyl carbonate (EMC) or a combination thereof. Other known solvent for the lithium-ion battery may also be used in the present invention.

### Embodiment

### Materials

4,4′-Diamino-4″-cyanotriphenylamine (Diamine-1, represented by the above formula (III-1)), N,N-bis(4-aminophenyl)-N′,N′-di(4-cyanophenyl)-1,4-phenylenediamine (Diamine-3, represented by the above formula (III-3)) and N,N′-di(4-nitrophenyl)-1,4-phenylenediamine were synthesized according to the previously reported procedure (L. Li, R. Kikuchi, M.-A. Kakimoto, M. Jikei and A. Takahashi, High Perform. Polym., 2005, 17, 135-147.; G. S. Liou, C. W. Chang, H. J. Yen, J. P. Pan, C. R. Yang, T. H. Wang, J. M. Hsu (Industrial Technology Research Institute ITRI), U.S. Pat. No. 8,088,932B2, 2012.; and I. Różalska, P. Kułyk and I. Kulszewicz-Bajer, New J. Chem., 2004, 28, 1235-1243.). Commercially available aromatic tetracarboxylic dianhydride 1,4,5,8-naphthalenetetracarboxylic dianhydride (NTDA) (TCI) was purified by vacuum sublimation. Carbon black, conductive carbon (super PR; >99% (metal basis)), polyvinylidene fluoride (PVDF, Alfa Aesar), N-methylpyrrolidone (NMP; >99%, Thermo Fisher Scientific), 1M lithium hexafluorophosphate (LiPF₆) in ethylene carbonate (EC) and diethyl carbonate (DEC) (1:1 v/v) was purchased from UBIQ Technology Co., Ltd. All materials were used as receive without further purification.

### Preparation of N,N-Bis(4-nitrophenyl)-N,N-di(4-cyanophenyl)-1,4-phenylenediamine

To a solution of 7.32 g (20.88 mmol) of N,N′-di(4-nitrophenyl)-1,4-phenylenediamine and 5.37 g (43.87 mmol) of 4-fluorobenzonitrile in 70 mL of dried dimethyl sulfoxide (DMSO), 6.96 g (45.37 mol) of dried cesium fluoride was added with stirring all at once, and the mixture was heated at 150° C. for 24 h under nitrogen atmosphere. The mixture was poured into methanol/water, and the precipitated red powder was collected by filtration and reprecipitated by N,N-dimethylformamide/methanol. The product was filtered to afford 8.58 g (74% in yield) of orange crystals with a mp of 349-351° C. FT-IR (KBr): 1312, 1584 cm⁻¹ (NO₂ stretch), 2223 cm⁻¹ (C≡N stretch). 1H NMR (500 MHz, DMSO-d₆, δ, ppm): 7.19 (d, J=9.2 Hz, 4H), 7.29 (s, 4H), 7.31 (d, J=8.8 Hz, 4H), 7.83 (d, J=8.8 Hz, 4H), 8.18 (d, J=9.2 Hz, 4H). ¹³C NMR (125 MHz, DMSO-d₆, δ, ppm): 105.87, 118.59 (—C≡N), 121.51, 124.18, 125.50, 128.45, 133.94, 141.52, 142.33, 149.34, 151.70. Anal. Calcd (%) for C₃₂H₂₀N₆O₄ (552.54): C, 69.56; H, 3.65; N, 15.21. Found: C, 69.32; H, 4.19; N, 15.15.

### Preparation of N,N-Bis(4-aminophenyl)-N,N-di(4-cyanophenyl)-1,4-phenylenediamine (Diamine-2, Represented by the Above Formula (III-2))

In a 250-mL three-neck round-bottomed flask equipped with a stirring bar under nitrogen atmosphere, 9.78 g (17.71 mmol) of N,N′-Bis(4-nitrophenyl)-N,N-di(4-cyanophenyl)-1,4-phenylenediamine and 0.40 g of 10% Pd/C were dissolved/suspended in 100 mL of tetrahydrofuran. The suspension solution was heated to reflux, and 5.0 mL of hydrazine monohydrate was added slowly to the mixture. After the solution was stirred at reflux temperature for 9 h, the solution was filtered to remove Pd/C, and the filtrate was cooled. The product was collected by filtration and dried in vacuo at 80° C. to give 8.34 g (96% in yield) of bright yellow powder with a mp of 278-283° C. FT-IR (KBr): 3359, 3444 cm⁻¹ (N—H stretch), 2220 cm⁻¹ (C≡N stretch). 1H NMR (500 MHz, DMSO-d₆, δ, ppm): 5.26 (s, 4H, —NH₂), 6.62 (d, J=8.6 Hz, 4H), 6.74 (d, J=9.0 Hz, 4H), 6.92 (d, J=8.6 Hz, 4H), 7.18 (s, 4H), 7.52 (d, J=9.0 Hz, 4H). ¹³C NMR (125 MHz, DMSO-d₆, δ, ppm): 99.04, 114.96, 116.31, 119.77 (—C≡N), 126.70, 128.61, 132.72, 133.15, 141.93, 147.55, 151.90. Anal. Calcd (%) for C₃₂H₂₄N₆ (492.57): C, 78.03; H, 4.91; N, 17.06. Found: C, 77.71; H, 5.34; N, 17.12.

### Preparation of Polynaphthalimide (PNIs) by One-Step Method

Three naphthenic polyimides (polynaphthalimides; PNIs) represented by the above formulas (I-1) to (I-3) were synthesized from diamine monomers and dianhydride NTDA. The synthesis of PNI-2 represented by the above formula (I-2) was used as an example to illustrate the general synthetic route. To a solution of 753.8 mg (1.54 mmol) of Diamine-2 in 7.0 mL of m-cresol, 410.4 mg (1.54 mmol) of NTDA was added in one portion, then 752.5 mg of benzoic acid was added. The mixture was heated at 80° C. for 2 h, and then at 210° C. for 15 h. The obtained polymer solution was poured slowly into 300 mL of stirred methanol giving rise to a brown fibrous precipitate that was collected by filtration, washed thoroughly with methanol, and dried under vacuum at 100° C. Reprecipitations of the polymer by N-methyl-2-pyrrolidone (NMP)/methanol were carried out twice for further purification. The inherent viscosity of PNI-2 was 0.45 dL/g in m-cresol at a concentration of 0.5 g/dL at 30° C.

### Material Characterization

Fourier transform infrared spectroscopy (FTIR) was measured on a FT/IR 6600, JASCO International Co., Ltd. Elemental analyses were run in a Heraeus VarioEL-III CHNS elemental analyzer. NMR spectra were measured on a Bruker AVANCE-500 FT-NMR spectrometer using tetramethylsilane as an internal reference, and peak multiplicity was reported as follows: s, singlet; d, doublet. The inherent viscosities were determined at 0.5 g/dL concentration using Tamson TV-2000 viscometer at 30° C. Thermogravimetric analysis (TGA) was conducted with a PerkinElmer Pyris 1 TGA. Experiments were carried out on approximately 6-8 mg film samples heated in flowing nitrogen or air (flow rate=20 cm³/min) at a heating rate of 20° C./min. The cyclic voltammetry were performed using MultiPalmSens4 electrochemical analyzer, PalmSens BV. The electrochemical impedance spectroscopy (EIS) analysis was conducted before and after battery cycle using CHI electrochemical workstation model 760e, CH Instruments, Inc. The cells were charged and discharge galvanostatically using AcuTech battery station systems (AcuTech Systems Co. Ltd). The galvanostatic intermittent titration technique (GITT) was performed using Squitstat potentiostats, Admiral Instrument.

### Electrode Preparations and Electrochemical Measurements

The electrodes used in this study were prepared using slurry method. In brief, the LiB cathode was prepared by mixing the active material (40 wt %), conductive carbon of super P (50 wt %), and PVDF (10 wt %). While, the anode is prepared by mixing 20 wt % active material with Super P as conductive carbon (70 wt %), and PVDF (10 wt %). Both mixtures were then dissolved in NMP forming a homogeneous slurry. The slurry was spread onto copper foil (anode) or aluminum foil (cathode) by using a doctor blade with the clearance of 100 μm. The slurry were then dried on the hot plate at 60° C. for 12 hours, and continued in the vacuum oven under 80° C. for another 8 hours. The electrodes were cut into 12-mm disks, and then transferred into the glovebox for cell assembling process. The average mass loading of 0.62, 0.56, and 0.46 mg cm-2 was obtained for PNI-1 (represented by the above formula (I-1)), PNI-2 (represented by the above formula (I-2)), and PNI-3 (represented by the above formula (I-3)) cathodes, respectively. While, the mass loading of PNI-1, PNI-2, and PNI-3 anodes was found around 0.78, 0.61, and 0.70 mg cm-2. In addition, the binder free cathode was prepared using the same method with ratio of active material (40 wt %) and Super P as the conductive carbon (60 wt %), resulting mass loading of 0.58 and 0.60 mg cm-2 for binder free PNI-1 and PNI-2, respectively.

Finally, the coin cells of CR2032-type were assembled in a high-purity argon-filled glovebox (H₂O<0.5 ppm, and O₂<0.5 ppm). Lithium foil with diameter of 12 mm used as counter electrode, Celgard 2325 as the separator, and 40 μL of 1 M LiPF₆ in a 1:1 (v/v) of ethylene carbonate/diethyl carbonate (EC/DEC) solution as electrolyte.

For electrochemical tests, the galvanostatic charge-discharge measurements were performed on a battery tester station (AcuTech Systems Co. Ltd) at voltage 1.5-4.5 V (vs. Li⁺/Li) for cathode and 0.02-3.0 V for anode. Cyclic Voltammetry (CV) measurements were performed using an electrochemical analyzer (MultiPalmSens4, PalmSens BV) at the same potential window with scan rate of 0.1 mV s⁻¹. The electrochemical impedance spectroscopy (EIS) analysis were conducted before and after battery cycle using CHI electrochemical workstation model 760e, CH Instruments, Inc., with frequency range between 10 mHz to 1 MHz and alternating current (AC) voltage signal of 10 mV. The galvanostatic intermittent titration technique (GITT) has been carried out to probe the ion diffusion of PNIs system. The GITT measurement was performed using Squitstat potentiostats, Admiral Instrument by alternating current density of 50 mA g⁻¹ for 20 min with a rest interval of 10 min. Prior the GITT measurement, fresh coin cells were fully charged under 50 mA g⁻¹ and allowed to rest for up to 10 hours. The diffusion coefficient was then calculated by the following formula:

$$D = \frac{4}{π τ} {( \frac{{m}_{B} {V}_{M}}{{M}_{B} S} )}^{2} {( \frac{Δ {E}_{s}}{Δ {E}_{t}} )}^{2}$$

where D is diffusion coefficient (cm² s⁻¹), τ is the current pulse (s), m_{B} is the mass of the host material in the electrode (g), V_{M} is the molar volume of the material (cm³ mol⁻¹), M_{B} is the molecular weight of the host material (g mol⁻¹), and S is the contact area of the electrolyte and electrode interface (cm²). ΔEₛ and ΔEₜ are the voltage responses over the relaxation and current pulse, respectively.

### Diffusion Coefficient Calculation Based on EIS Data

Electrochemical impedance spectroscopy (EIS) is a powerful tool to probe the electrochemical phenomena that occur in the complex electrochemical systems such as battery cells. In general, the Nyquist plot of EIS spectra present electrochemical process in the three different frequency regions. First, the conduction across electrolyte, separator, and wires was reflected in the high frequency area. Furthermore, the mid frequency is the region represents the charge transfer and kinetic reactions, while the low frequency region is typically with slope of 45°, represents the diffusion limited region in the solid phase and is typically characterized by the Warburg impedance. Additionally, the Warburg impedance can be defined by:

$${Z}^{′} = σ / {ω}^{\frac{1}{2}} - j σ / {ω}^{\frac{1}{2}}$$

$$\vert - {Z}^{″} \vert = √ 2 σ / {ω}^{\frac{1}{2}}$$

where Z′ and Z″ are real and imaginary impedance, respectively. While, @ is the angular frequency and σ is the Warburg coefficient. Warburg coefficient (σ) can be determined by the slope of Warburg plot (Z′ vs 1/ω^{1/2}). In Li ion battery, the relationship of Warburg coefficient (σ) and the diffusion coefficient (D) is given by:

$$σ = \frac{R T}{{n}^{2} {F}^{2} A \sqrt{2}} ( \frac{1}{{D}_{L i}^{1 / 2} {C}_{L i}} )$$

where R is ideal gas constant, Tis absolute temperature, n is the number of electron transferred, F is Faraday's constant, A is the area of the electrode, D_{Li} and C_{Li} are the diffusion coefficient and concentration of Lit, respectively.

### Sweep Rate Voltammetry for Charge-Storage Characteristic

The sweep rate voltammetry is one of powerful technique that could to probe a consecutive electrochemical reaction which occurs in the electrodes. In general, the total charge in a CV curve can be classified into three components: (a) the faradaic contribution from the Li⁺ ion diffusion process; (b) the faradaic contribution from the charge-transfer process with surface atoms, referred to as pseudocapacitance; (c) the non-faradaic contribution from the double layer effect. Moreover, the contribution of both types capacitive effects, such as pseudocapacitance and double layer effect, can be substantial due to the increasing surface area of the electrode. These faradaic contribution from diffusion-control and surface-control (capacitive effects) process can be characterized using CV data at various scan rates and expressed by the following formula:

$$i = a {v}^{b}$$

where i is current response to the scan rate v, while a and b are constants. The b value can be obtained from the slope of log i vs log v. In addition, if the b value close to 0.5 would indicate half-infinite linear diffusion controlled process, meanwhile b value close to 1 indicates the current is surface controlled. Since the b value is the sum of faradaic response of diffusion controlled and capacitive effects, a closer examination from sweep rate voltammetry can be applied to quantify the capacitive effects (k₁v) and diffusion controlled behavior (k₂v^{1/2}) by following formula:

$$i = {k}_{1} v + {k}_{2} {v}^{1 / 2}$$

The k₁ and k₂ values can be determined by plotting i/v^{1/2} vs v^{1/2}.

### Results

### Redox Properties of TPA-PNI (Triphenylamine-Based Polynaphthalimides) Electrodes

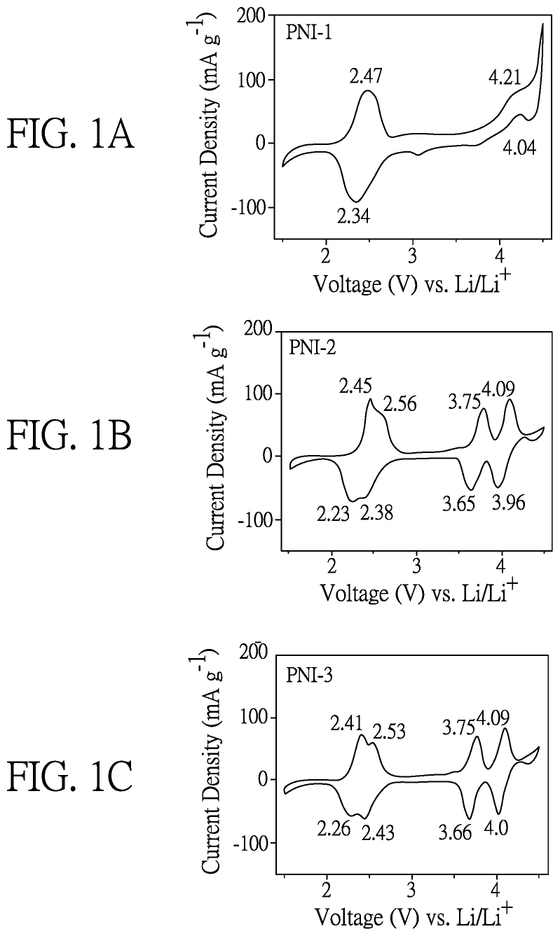

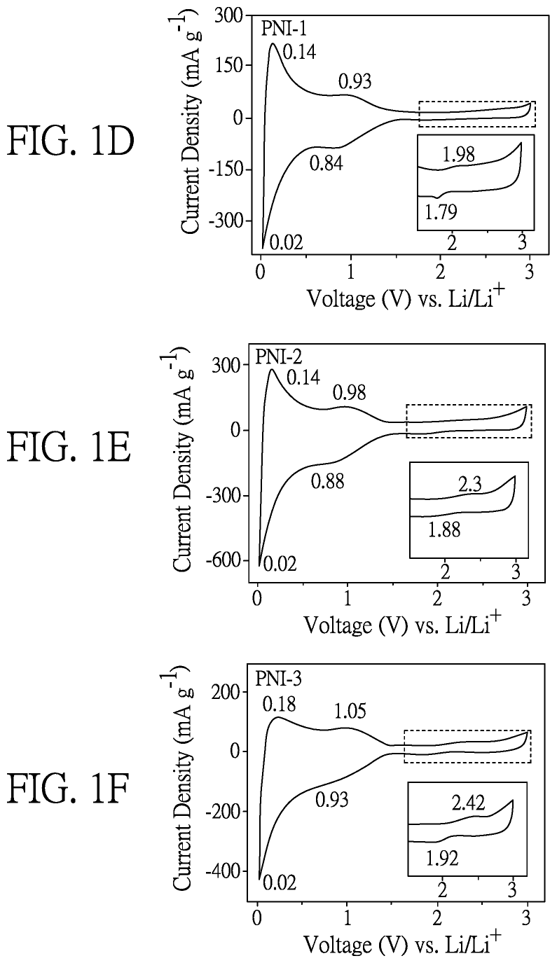

To probe the redox properties, cyclic voltammetry (CV) measurement was carried out by applying TPA-PNIs as both LiB cathode and anode materials (FIG. 1A to FIG. 1F). As cathode, the CV of TPA-PNIs was performed in the potential window ranged between 1.5 and 4.5 V (vs Li/Li) at a scan rate of 0.1 mV s⁻¹; while as anode, it was operated within 0.02 and 3.0 V (vs Li/Li⁺). As shown in FIG. 1A, one reduction peak can be monitored at 2.34 V in the cathodic scan of PNI-1 cathode, along with oxidation peaks at 2.47 V in anodic scan. These pair redox peaks is associated with the two-electron enolization reaction process of naphthalenediimide (NTDI) unit. Furthermore, the oxidation and reduction process of radical cations triarylamine unit in the PNI-1 can be observed at 4.21 and 4.04 V, suggesting a successful doped/de-doped process of PF⁶⁻ anion. Interestingly, the well-defined two reduction peaks of NTDI unit in PNI-2 can also be observed in the cathodic scan and slightly shifted to a lower voltage at 2.23 and 2.38 V (with ~0.15 V difference), along with the oxidation peaks at 2.45 and 2.56 V, than that of PNI-1 (FIG. 1B). This phenomena could be ascribed to the present of two cyano groups in PNI-2. The electron withdrawing character of cyano group has been reported lower the LUMO energy of polyimide and make it more reducible. Additionally, PNI-3, which is a structural isomer of PNI-2, exhibited slightly higher reduction potential of NTDI unit at 2.26 and 2.43 V (with a higher potential difference of ~0.17 V; FIG. 1C). This suggests that different conformation of cyano group in the polymer backbone plays important role on tuning the intrinsic properties of TPA-PNIs. At higher operation voltage, both PNI-2 and PNI-3 showed almost identical redox pairs at ~3.65/3.75 and 3.96/4.09 V (FIG. 1B and FIG. 1C), which can be ascribed to the doped/de-doped process of PF₆⁻ anion in the two radical nitrogen atom of diamine units. The first redox couple at 3.65/3.75 V is attributed to the first radical cation reaction during the p-type doping process, another redox couple at higher potential (3.96/4.09 V) is associated with the reaction of second radial cation.

To further evaluate the TPA-PNI electrodes, we also elucidated its redox properties as anode (FIG. 1D to FIG. 1F). As shown in FIG. 1D to FIG. 1F, all TPA-PNIs exhibited almost identical CV curves when applied as LiB anodes. As shown in FIG. 1D, three reduction peaks are observed at the potential of 1.79, 0.84, and 0.02 V for PNI-1, accompanied with three oxidation peaks at 1.98, 0.93, and 0.14 V, respectively. The first redox peak at 1.79/1.98 V could be attributed to the redox reaction of carbonyl NTDI unit during lithiation-delithiation process. Meanwhile, the redox process at 0.84/0.93 V is ascribed to Li⁺ insertion/de-insertion on cyano group. The Li⁺ insertion/de-insertion on the carbonaceous units was monitored at 0.02/0.14 V. Although both PNI-2 and PNI-3 have similar CV behavior with PNI-1, it is important to note that the redox potential associated with NTDI unit was found at slightly higher potential than that of PNI-1 (FIG. 1E to FIG. 1F). This behavior could be related to the introduction of two cyano groups with a higher charge polarization and the nature of electron-withdrawing character. Furthermore, it is also found that the redox potential associated with NTDI unit in PNI-3 is slightly higher than that of PNI-2. This again confirm that conformational unit position tune the intrinsic electrochemical behavior of TPA-PNI based electrodes.

### Battery Performance of TPA-PNI Cathodes

To evaluate the battery performance of TPA-PNI cathodes, half-cell LiB has been assembled and galvanostatically charged-discharged at potential window of 1.5-4.5 V (vs. Li/Li⁺). Even not shown in the figure, the results of the galvanostatic charge and discharge profile of TPA-PNI cathodes at current density of 50 mA g⁻¹ show that PNI-1 cathode exhibited a specific capacity of 125 mA h g⁻¹ (after 100 cycles) along with a major plateau at 2.47 V. This plateau can be assigned to enolization and dianion formation of NTDI unit. Notably, the plateau that ascribed to doped/de-doped process of PNI-1 is hardly seen in the galvanostatic profile. Furthermore, three plateaus can be monitored at 2.27, 3.67, and 3.98 V for PNI-2 and PNI-3, indicating the successful formation of lithium enolate and dianion of NTDI unit and doped/de-doped process of nitrogen radical cation in TPPA moiety. Interestingly, although PNI-2 and PNI-3 showed almost identical galvanostatic profile, PNI-2 has significant higher storage capacity (195 mA h g⁻¹) than that of PNI-3 (170 mA h g⁻¹). This further indicates that the structural design plays an important role on the TPA-PNIs performance.

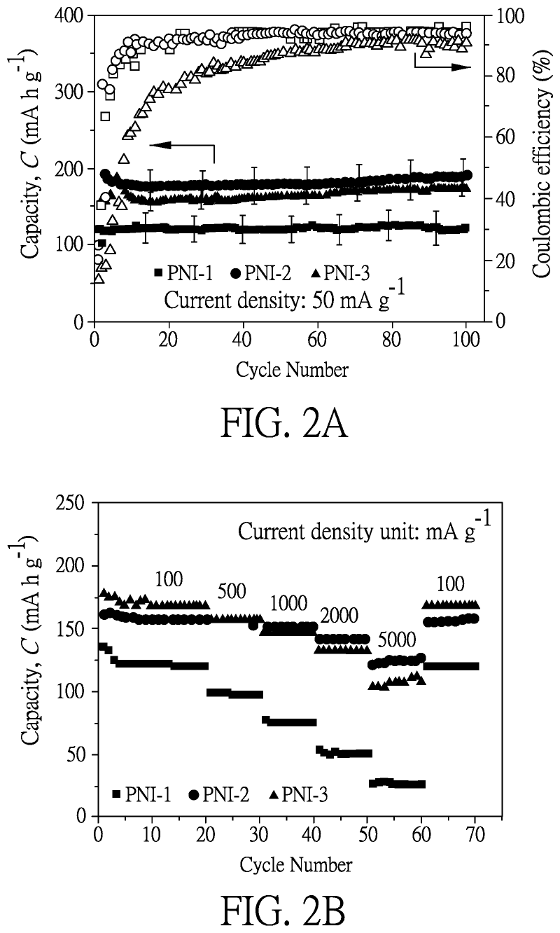

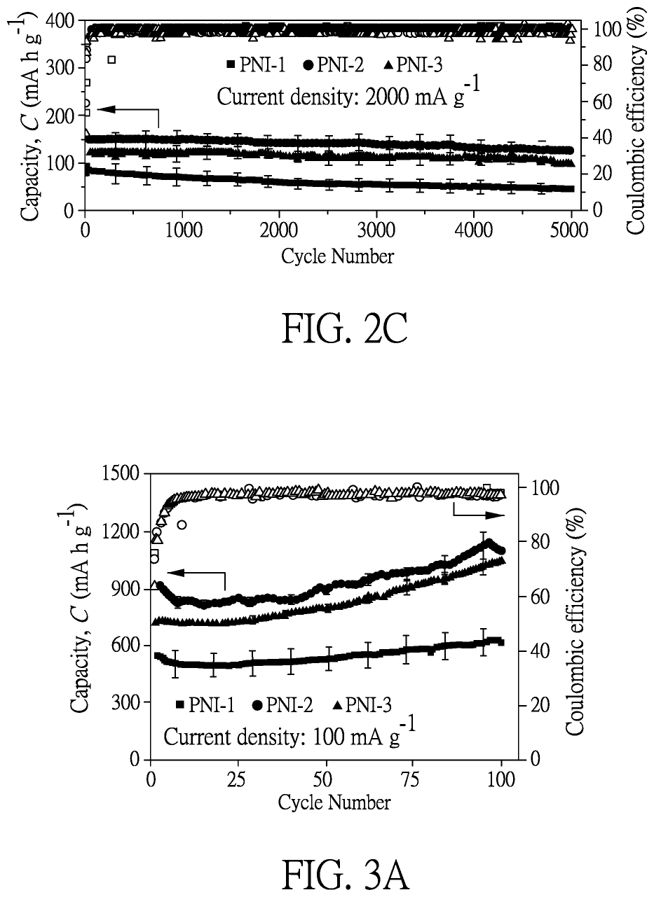

FIG. 2A showed the capacity profile of TPA-PNI cathodes at current density of 50 mA g⁻¹. As shown in FIG. 2A, all TPA-PNI cathodes demonstrated stable cycling performance for up to 100 cycling. Notably, PNI-2 cathode exhibited the highest storage capacity of 195 mA h g⁻¹, with ~95% Coulombic efficiency (CE), after 100 cycles at 50 mA g⁻¹ than that of PNI-1 (125 mA h g⁻¹) and PNI-3 (170 mA h g⁻¹), indicating that proper structural design significantly boost the performance of TPA-PNI cathodes. Additionally, the PNI-2 and PNI-3 showed remarkable rate capability up to 5000 mA g⁻¹ (FIG. 2B). The PNI-2 demonstrate specific capacity of 162, 155, 151, 141, and 124 mA h g⁻¹ at 100, 500, 1000, 2000, and 5000 mA g⁻¹ current densities, respectively. While, specific capacities of 170, 153, 145, 134, and 112 mA h g⁻¹ can be obtained by PNI-3 at current densities of 100, 500, 1000, 2000, and 5000 mA g⁻¹. Unlike PNI-2 and PNI-3, PNI-1 cathode exhibited a relatively low rate capability performance. As depicted in FIG. 2B, the specific capacity of PNI-1 was significantly dropped from 120, 98, 75, 47, and 26 mA h g⁻¹ when the current density varied from 100, 500, 1000, 2000, and 5000 mA g⁻¹, respectively. Even so, the long-cycling performance indicated that all the TPA-PNI cathodes demonstrated excellent stability and reversibility by retaining their high capacity up to 130 mA h g⁻¹ over 5000 cycles under high current density of 2000 mA g⁻¹ (FIG. 2C).

### Battery Performance of TPA-PNI Anodes

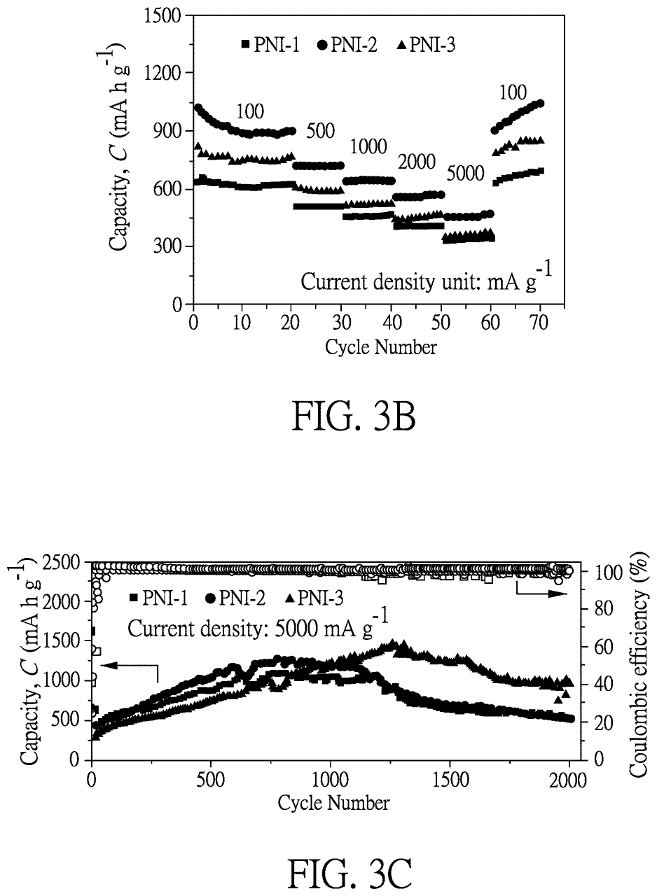

To probe the capability of TPA-PNIs as LiB anodes, half-cell Li-ion was again fabricated and galvanostatically charged-discharged at potential window between 0.02-3.0 V (vs. Li/Li⁺). Even not shown in the figure, two major plateaus can be monitored for all TPA-PNI anodes at ~0.9 and 0.02 V, along with slightly increased capacity during cycling process at 100 mA g⁻¹ This similar plateaus in galvanostatic profile indicates an identical Li⁺ ion storage characteristic for all of the TPA-PNI anodes, which is in good agreement with the CV tests (FIG. 1D to FIG. 1F). Moreover, the PNI-1 anode exhibited specific discharge capacity of 520 mA h g⁻¹ during initial 5 cycles, before it gradually increased up to 650 mA h g⁻¹ after 100 cycles. While, PNI-2 and PNI-3 anodes also demonstrated gradual capacity increase up to 1100 mA h g⁻¹ after 100 cyclic scans. In a line with the galvanostatic profile, the increasing specific capacity is clearly depicted in the profile (FIG. 3A). The overall increased capacity during cycling can be associated by two parameters: first, it could be assigned to the increasing Li transport during cycling process; second, it was related to the activation period for TPA-PNIs to get Li-binding sites fully lithiated.

Furthermore, the TPA-PNI anodes showed excellent rate capability up to 5000 mA g⁻¹ (FIG. 3B). As shown in FIG. 3B, the reversible capacities of 611, 508, 460, 408, and 344 mA h g⁻¹ were obtained for PNI-1 anode when the current density is varied from 100, 500, 1000, 2000 to 5000 mA g⁻¹, respectively. In good agreement with capacity profile, PNI-2 again delivered the highest specific capacity of 920, 756, 632, 582 and 450 mA h g⁻¹ at 100, 500, 1000, 2000 and 5000 mA g⁻¹ current density, respectively. While, PNI-3 exhibited specific capacity of ~760, 605, 490, 410 and 350 mA h g⁻¹ at 100, 500, 1000, 2000 and 5000 mA g⁻¹ current density. The outstanding rate capability was confirmed by the recoverable specific capacity of 650, 1130, and 970 mA h g⁻¹ for PNI-1, PNI-2, and PNI-3, respectively, when the current density was switched back to 100 mA g⁻¹ (FIG. 3B). Moreover, the long cycling performance indicated that TPA-PNI anodes could sustain up to 2000 cycles under significant high current density of 5000 mA g⁻¹ (FIG. 3C). As shown in FIG. 3C, the peak capacity of 1000, 1350, and 1375 mA h g⁻¹ was observed by PNI-1 (after 625 cycles), PNI-2 (after 680 cycles), and PNI-3 (after 1250 cycles), respectively.

### Mechanistic Studies of TPA-PNI Electrodes

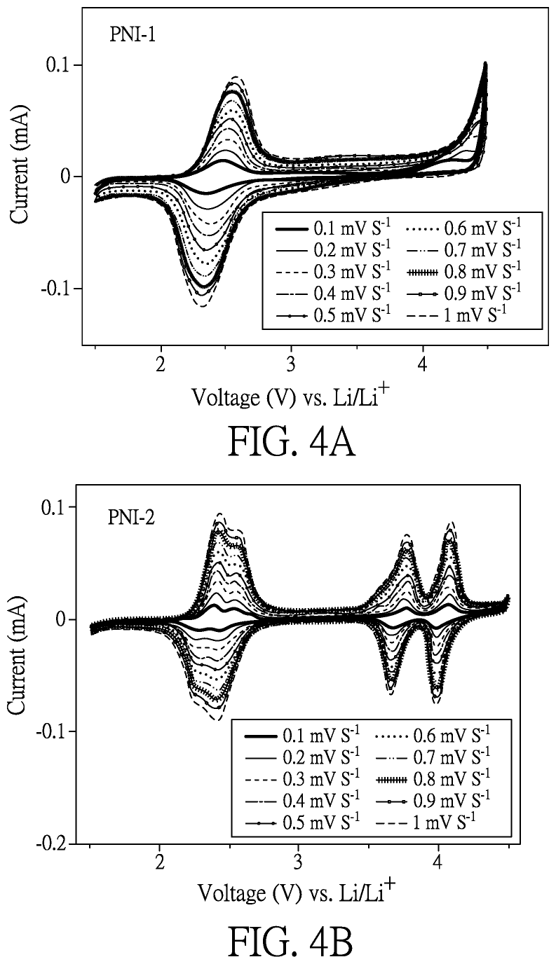

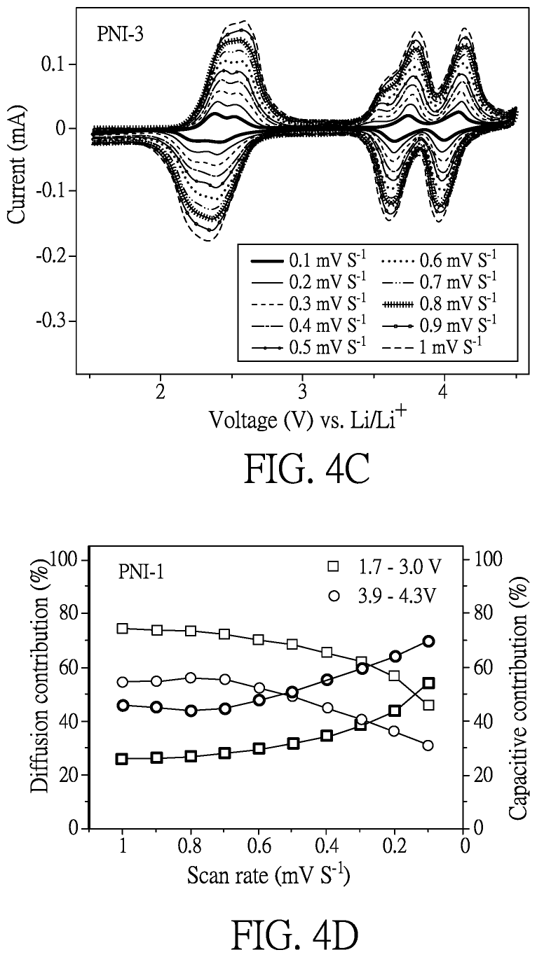

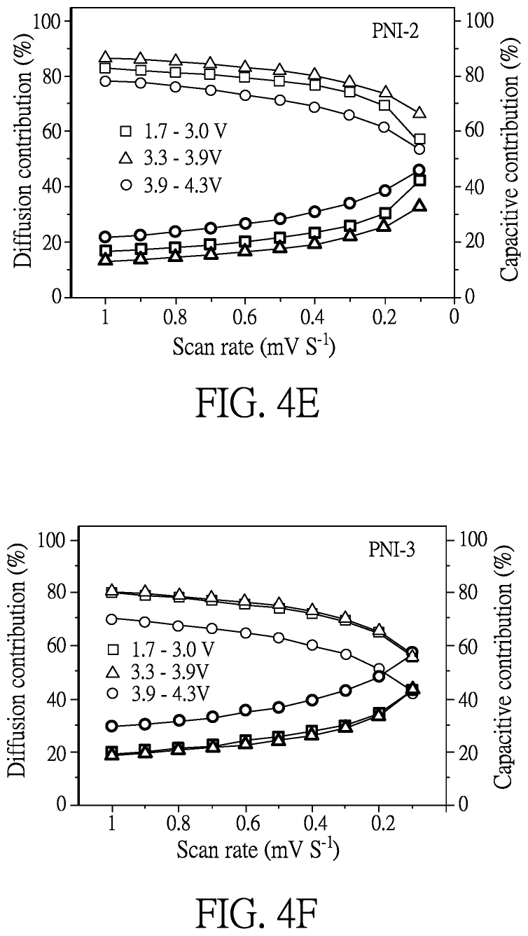

To gain a better understanding of the charge storage behavior for diamine and NTDI units in TPA-PNI electrodes, sweep rate CV analysis has been applied at various scan rate of 0.1-1.0 mV s⁻¹. FIG. 4A to FIG. 4C showed the typical CV curves of PNI-1, PNI-2, and PNI-3 cathodes, respectively, at various scan rates, depicting a gradual increase on the total current as the scan rate varied from 0.1 to 1.0 V. Further analysis on the total current at different voltage range reveals that the b-value of TPA/TPPA and NTDI units in the TPA-PNIs was ranging from 0.61-0.89 (data not shown), indicating that the total charge stored in TPPA and NTDI unit were resulted from synergetic contribution of diffusion and surface-controlled (capacitive) process. The quantitative analysis of capacitive (k₁v) and diffusion (k₂v^{1/2}) contribution in the TPPA and NTDI units of TPA-PNI cathodes can be obtained from the slope and the intercept from the i/v^{1/2} against v^{1/2} plot (data not shown). As shown in FIG. 4D, the NTDI unit (voltage range 1.7-3.0 V) in PNI-1 exhibited nearly 70% capacitive contribution a higher scan rate of 1-0.5 mV s⁻¹, before gradually decreasing up to 46% at 0.1 mV s⁻¹. Similar trend can be observed at TPA unit (voltage range 4.0-4.3 V) in PNI-1, which showed gradual decrease in capacitive contribution from ~50% at higher scan rate of 1-0.5 mV s⁻¹ to 34% at scan rate of 0.1 mV s⁻¹.

Interestingly, replacing diamine unit from TPA to TPPA significantly tune the charge storage characteristics of TPA-PNIs. As depicted in FIG. 4E and FIG. 4F, attaching TPPA unit in PNIs, as PNI-2 and PNI-3, drastically increase the capacitive contribution in the total charge stored of NTDI unit by nearly 80% at a higher scan rate of 1-0.5 mV s⁻¹ and 40% at the lowest scan rate of 0.1 mV s⁻¹. Furthermore, the two radicals of nitrogen in TPPA exhibited almost similar behavior by delivering nearly 80% capacitive contribution at scan rate of 1-0.5 mV s⁻¹ and gradually reduced to ~55% at 0.1 mV s⁻¹ (FIG. 4E and FIG. 4F). This could be resulted from —C≡N functional group that makes almost identical electronic environment of TPPA. As shown in FIG. 4F, the diffusion contribution in the NTDI unit from PNI-3 was increased nearly 3% than that of PNI-2. The increasing diffusion contribution can also be observed for TPPA unit (FIG. 4E). The diffusion contribution on the first radical cation, which is close to the nitrogen atom with two —C≡N functional groups (at potential 3.3-3.9 V), was found to exhibit ~5% more in diffusion contribution at a higher scan rate of 1-0.5 mV s⁻¹ and almost 10% increase at the lowest scan rate of 0.1 mV s⁻¹ (FIG. 4F) than that of PNI-2 (FIG. 4E). Meanwhile, the second radical cation at potential ranged 3.9-4.3 V (close to naphthalimide linkage) has even higher diffusion contribution of 8% at scan rate of 1-0.5 mV s⁻¹ and 12% at 0.1 mV s⁻¹ (FIG. 4F), than that of PNI-2 (FIG. 4E). This is again confirmed that different conformational position in the polymer backbone plays an important role on tuning the charge storage behavior.

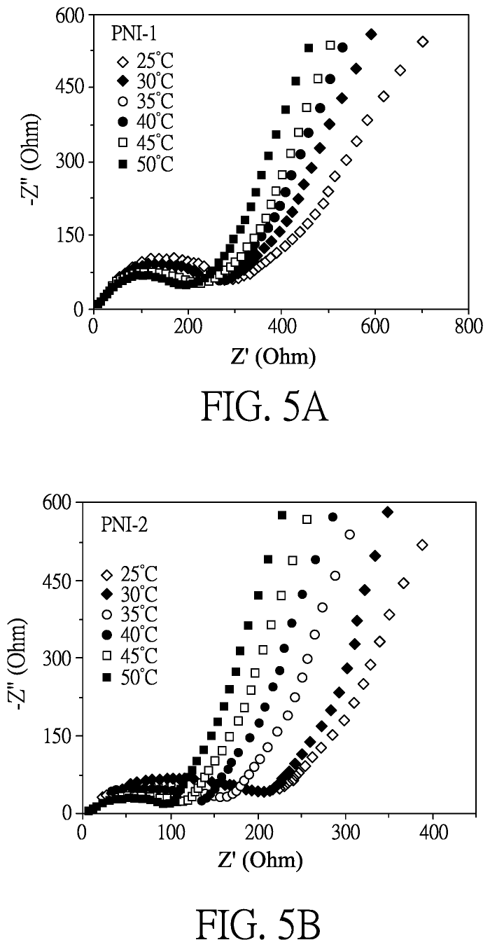

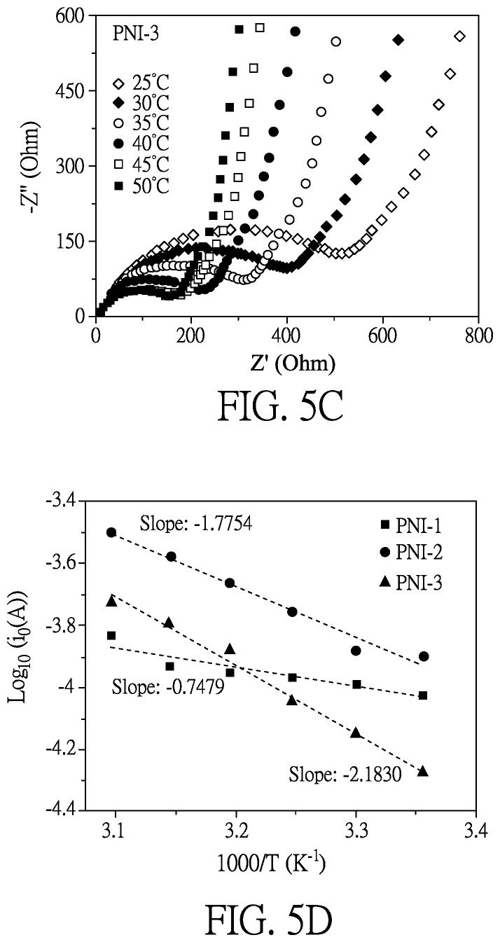

In addition, the EIS measurement was then employed to further evaluate the activation energy. It has been reported that the relationship between exchange current (i₀) and charge transfer resistance at electrode interface (R_{ct}) at various temperatures could be used to estimate the activation energy using Arrhenius equation: i₀=RT/nFR_{ct} and i₀=A exp(−Eₐ/RT), where A is a temperature-independent coefficient, R is the gas constant, T (K) is the absolute temperature, n is the number of transferred electrons, F is Faraday constant and Eₐ is apparent activation energy. As shown in FIG. 5A to FIG. 5C, all the TPA-PNIs exhibited one semicircle which gradually reduced as increasing the temperature, clearly indicates the decreasing R_{ct}. Furthermore, the activation energies (Eₐ) of TPA-PNIs can be estimated from: Eₐ=−Rk ln 10, k=the slope of the fitting line of the Arrhenius plots (Log 10i₀ as a function of 1000/T) (FIG. 5D). The Eₐ of TPA-PNIs were then estimated to be 14.35, 33.98 and 41.79 kJ mol⁻¹ for PNI-1, PNI-2, and PNI-3, respectively. Interestingly, the lowest Eₐ resulted from PNI-1 indicates that the structure with TPA unit requires the minimum energy to promote charge transfer reaction than others. Notably, PNI-3 was found has a higher Eₐ of 41.79 kJ mol⁻¹ than that of PNI-2 (33.98 kJ mol⁻¹), indicating more energy are required to activate its charge transfer reaction. The higher Eₐ required for PNI-3 could be resulted from a higher charge polarization in the molecular structure, which is also consistent with the capacity profile that PNI-3 exhibited a slightly lower capacity than that of PNI-2 as both cathode and anode. In brief, it is found that different molecular structure and conformation play crucial roles on tuning the charge storage behavior and activation energy of TPA-PNIs, thus further impact their electrochemical performance as LiB electrode materials.

### Battery Performance of Binder-Free PNI Electrodes

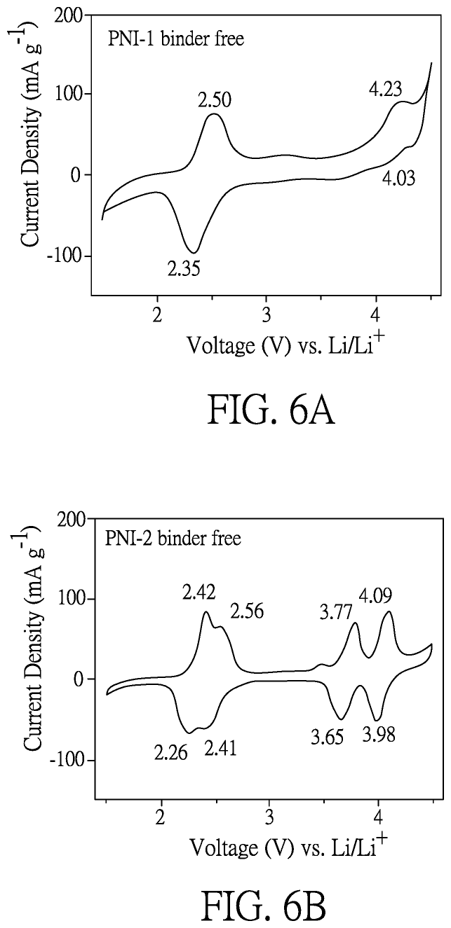

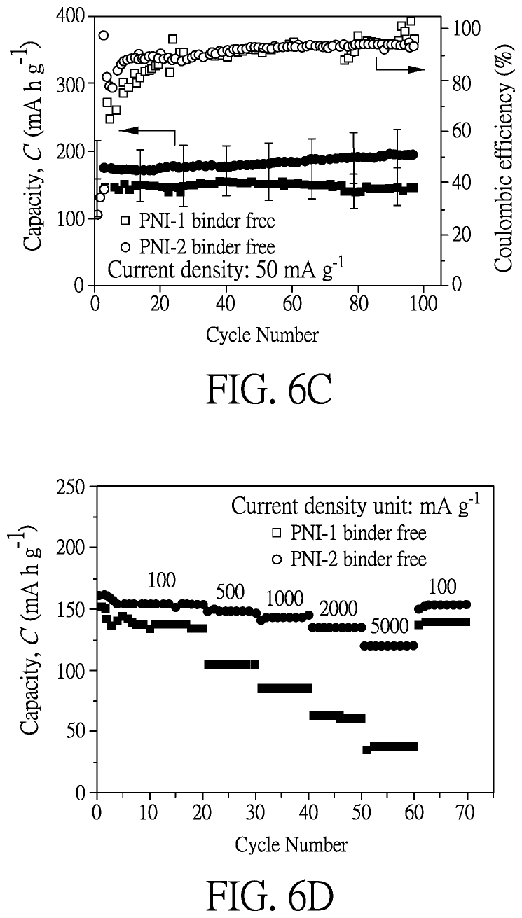

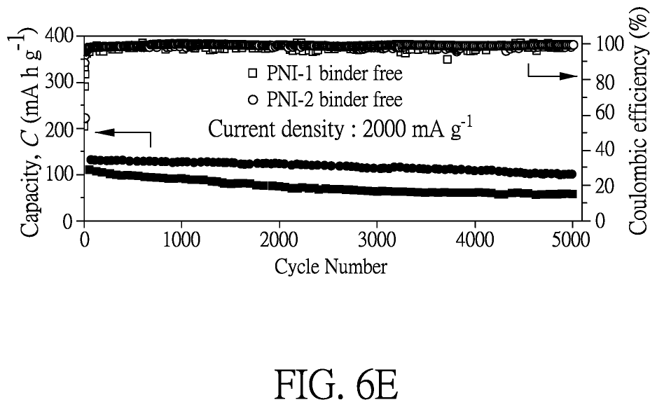

To further investigate the multi-functional capability of TPA-PNIs as cathode/anode materials and electrode binder simultaneously, we performed the battery test with binder-free cathode (with weight ratio of active material and conductive carbon as 40:60) for PNI-1 and PNI-2. As shown in FIG. 6A and FIG. 6B, no significant change can be observed on the CV curve of binder-free electrodes from the electrodes containing PVDF binder, indicating a well-preserved redox capability. The binder-free PNI-1 (FIG. 6A) exhibited reduction peaks at 2.35 V, along with its oxidation at 2.50 V, which corresponds to enolization process on the NTDI unit. While, the PF⁶⁻ doped/de-doped process on TPA is observed at 4.23/4.03 V. Furthermore, PNI-2 has also demonstrated well preserved redox capability by exhibiting its pair redox potential for enolization process on NTDI and doped/de-doped process TPPA (FIG. 6B). Additionally, the galvanostatic profile of binder-free cathodes (data not shown) showed a good agreement with their CV results. Even not shown in the figure, two plateaus at 2.47 and 2.34 V can be monitored for binder-free PNI-1, which can be assigned to enolization process of NTDI unit. However, the plateau associated with doped/de-doped process originated from TPA is difficult to be observed in the galvanostatic profile. Additionally, the binder free PNI-2 exhibited four plateaus at 2.27, 2.41, 3.67, and 3.98 V, indicating the successful formation of lithium enolate and dianions of NTDI unit, as well as doped/de-doped process of TPPA.

Furthermore, the cycling performance of binder-free PNI-1 and PNI-2 (FIG. 6C) at 50 mA g⁻¹ exhibited a comparable specific capacity with that of binder (FIG. 2A). As shown in FIG. 6C, the binder-free PNI-1 and PNI-2 cathodes showed a stable cycling performance for up to 100 cycling with capacity of 160 and 202 mA h g⁻¹ at 50 mA g⁻¹. This specific capacity was even higher than their respective electrodes with PVDF binder (FIG. 2A). To manifest this phenomena, EIS measurement was again applied to understand the transport properties in binder-free cathodes. Even not shown in the figure, a significant reduction on the semicircle can be monitored on both binder-free PNI-1 and PNI-2 after cycling. This reducing semicircle is associated with significantly reduced Ret of binder-free cathodes, from 222.03 to 119Ω for PNI-1 and 313.96 to 57.64Ω for PNI-2, respectively, indicating a better transport ability after cycling. Notably, the higher D_{Li}⁺ value of binder-free cathodes than that with PVDF binder might be resulted from the homogeneous slurry formation, even without PVDF binder, and a higher conductive content of binder free cathode (60% Super P) than that of with binder (50% Super P), thus significantly improve the transport property and storage capability.

Beside the superior capacity, both binder-free PNI-1 and PNI-2 cathodes also exhibited excellent rate capability up to 5000 mA g⁻¹ in current density (FIG. 6D). The excellent rate performance is confirmed by its highest storage capacity of 137 mA h g⁻¹ (binder-free PNI-1) and 152 mA h g⁻¹ (binder-free PNI-2) can be recovered when the current density is turned back to 100 mA g⁻¹. Furthermore, both binder-free PNI-1 and PNI-2 cathodes showed exceptional long cycling stability up to 5000 cycles under high current density of 2000 mA h g⁻¹ (FIG. 6E). As shown in FIG. 6E, the long cycling capability is confirmed by maintaining capacity retention more than 45% and 75% for binder-free PNI-1 and PNI-2, respectively. The electrochemical performance further suggested that TPA-PNIs can serve as multi-functional components in LiBs as active materials and binder simultaneously.

In the present invention, polynaphthalimides (TPA-PNIs) are provided, which were prepared from the triphenylamine-based diamine monomers and further fabricated as battery electrode materials. The triphenylamine-based skeleton was chosen to be incorporated into polymer main-chains to provide more accessible active sites and enable efficient electron transfer during electrochemical process. The nitrogen radical in triphenylamine structure was able to actively participate in the electrochemical redox process which can be reversibly doped and dedoped PF⁶⁻ anion, thus enhancing the working voltage up to 4.2 V.

In addition, we have demonstrated an efficient storage capability of newly designed triphenylamine-based polynaphthalimides (TPA-PNIs) which can work as both cathode and anode for lithium ion battery, simultaneously. By taking advantages of high capacity and low solubility of naphthalimide, the hybrid TPA-PNIs exhibited outstanding electrochemical performance and operation durability. As cathode, the TPA-PNI cathode could deliver a high specific capacity up to 195 mA h g⁻¹ at 50 mA g⁻¹ after 100 cycles. Meanwhile, a maximum capacity of 1092 mA h g⁻¹ can be stored in the TPA-PNI anode after 100 cycles at 100 mA g⁻¹. In addition, the binder-free TPA-PNI cathode could deliver stable cycling performance with a maximum capacity of ~202 mA h g⁻¹ at 50 mA g⁻¹ after 100 cycles. Furthermore, the TPA-PNI electrodes also demonstrated good cycling stability over 5000 cycles under high current density of 2000 mA g⁻¹, with capacity retention of more than 75%, as well as an excellent rate capability up to 5000 mA g⁻¹. The mechanistic studies revealed that the outstanding electrochemical performances of TPA-PNIs are highly related with the proper structural design thus fine-tuned their activation energy and charge-stored behavior as well as cycling stability.

Although the present disclosure has been explained in relation to its embodiment, it is to be understood that many other possible modifications and variations can be made without departing from the spirit and scope of the disclosure as hereinafter claimed.

1. A polynaphthalimide comprising a repeat unit represented by the following formula (I): 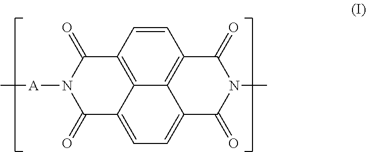
wherein A is a cyano-substituted arylamine moiety.

2. The polynaphthalimide of claim 1, wherein A is represented by the following formula (II): 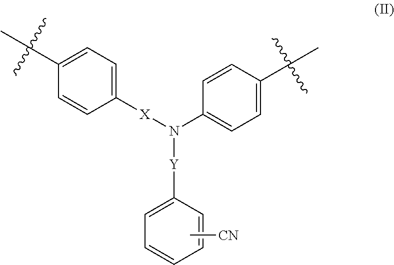
wherein X is a bond or 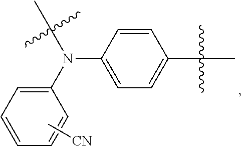
and Y is a bond or 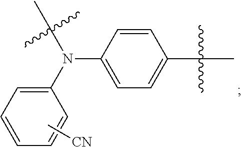
and
with the proviso that N of X or Y is not bond to N in the formula (II).

3. The polynaphthalimide of claim 1, wherein A is represented by the following formula (II-1): 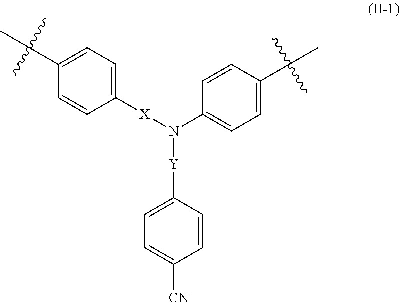
wherein X is a bond or 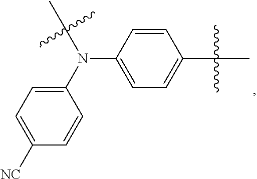 [SMILES: *c1ccc(N(*)c2ccc(C#N)cc2)cc1]
and Y is a bond or 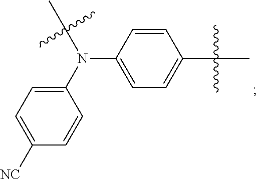 [SMILES: *c1ccc(N(*)c2ccc(C#N)cc2)cc1]
and with the proviso that N of X or Y is not bond to N in the formula (II-1).

4. The polynaphthalimide of claim 1, wherein the repeat unit is any one represented by the following formulas (I-1), (I-2) and (I-3):

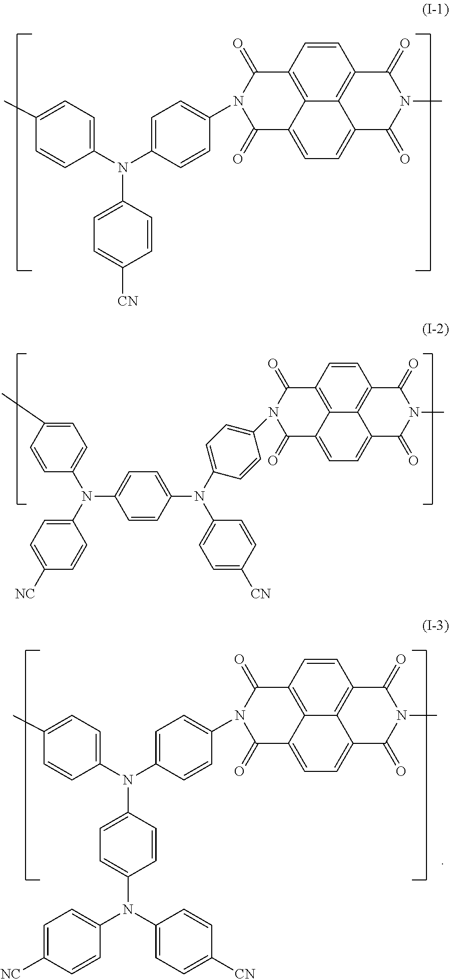

5. An electrode, comprising:
a collector; and
an electrode material disposed on the collector and comprising the polynaphthalimide of claim 1.

6. The electrode of claim 5, wherein the electrode is a cathode.

7. The electrode of claim 5, wherein the electrode is an anode.

8. The electrode of claim 5, wherein the electrode material further comprises:
an active material;
a conductive carbon; and
a binder,
wherein an average mass loading of the polynaphthalimide ranges from 0.2 mg/cm² to 1.0 mg/cm².

9. The electrode of claim 8, wherein a content of the active material is 20 wt % to 60 wt %, a content of the conductive carbon is 30 wt % to 70 wt %, and a content of the binder is 2 wt % to 15 wt % based on a total weight of the electrode material.

10. The electrode of claim 5, wherein the electrode material further comprises:
an active material; and
a conductive carbon,
wherein an average mass loading of the polynaphthalimide ranges from 0.2 mg/cm² to 1.0 mg/cm², and no other binders are present in the electrode material.

11. The electrode of claim 10, wherein a content of the active material is 20 wt % to 70 wt % and a content of the conductive carbon is 30 wt % to 80 wt % based on a total weight of the electrode material.

12. A lithium-ion battery, comprising:
an electrode, comprising: a collector; and an electrode material comprising the polynaphthalimide of claim 1;
a counter electrode disposed opposite to the electrode; and
an electrolyte disposed between the electrode and the counter electrode.

13. The lithium-ion battery of claim 12, wherein the electrode is a cathode.

14. The lithium-ion battery of claim 12, wherein the electrode is an anode.

15. The lithium-ion battery of claim 12, wherein the electrolyte comprise a lithium salt.
